(19) United States
(12) Patent Application Publication
(10) Pub. No.: US 2016/0316793 A1
(43) Pub. Date: Nov. 3, 2016

(54) FREE FLOWING NUTRITIONAL POWDER AND METHOD FOR ITS MANUFACTURE

(71) Applicant: Plant Science Laboratories, LLC, Buffalo, NY (US)

(72) Inventor: Michael BARNHART, Buffalo, NY (US)

(21) Appl. No.: 14/702,047

(22) Filed: May 1, 2015

(51) Int. Cl. A23L 1/30

(52) U.S. Cl. CPC A23L 1/3002; A23V 2002/00

(57) ABSTRACT

A free flowing nutritional powder includes a primary component originating or derived from fruits, vegetables, grasses, herbs, algae, and combinations thereof, along with an intimate mixture of 2 additional components including: 0.1-5.0% of lecithin and 0.1-5.0% of introduced hydrocolloid material. The dried material has powder has a mass weighted particle size within the range of 10-600 microns, said free flowing powder has a water activity of less than 0.50_{wa}, and said powder contains at least 85 wt. % of a fruit, vegetable, grass, herbal or algal component as the primary component.

### BACKGROUND OF THE INVENTION

1. Field of the Invention

Free flowing nutritional powders are suitably applied in fabrication of encapsulated nutritional products.

2. Description of the Related Art

Encapsulated nutritional products include a wide variety of powders originating or derived from botanical sources including fruits, vegetables, grasses, herbs, algae and combinations thereof. Nutritional products are supplied to the consumer as encapsulated materials in bottled products bearing labels indicating compositional basis and nutrition facts. Such encapsulated nutritional powder products are generally consumed in a capsule form to supplement meals with specific nutritional compounds.

Particle size reduction processing of dry or dehydrated materials that milling agents are employed to enhance the size reduction process. Such milling agents can provide process enhancements by increasing processing flow rate and size reduction, but have the disadvantage of requiring additional equipment to introduce the milling agent at the desired level in proper proportion to the primary material. Such milling agents may also introduce additional non typical food item materials or incompatible colored materials into the finished powder which may not be desired.

In encapsulation processing of nutritional materials, excipient agents are often required to enhance the flow rate of powders in order to ensure that the proper quantity of powder is introduced into the finished capsule. Such excipient agents can provide process enhancements by increasing encapsulation fill and production rate, but have the disadvantage of requiring additional equipment to introduce the excipient agent at the desired level in proper proportion to the primary material. Such excipient agents may also introduce additional non typical food item materials into the finished capsule which may not be desired. Such excipient agents may also introduce a visually non compatible color of powder which may not be visibly appealing as specks of the excipient may appear in the finished capsule.

Although there are a large number of encapsulated products available to consumers, there is a need to eliminate non-typical food milling agents and non-typical food excipient agents in encapsulation processing in order to eliminate incompatible coloration issues and meet consumer demands for purity and composition.

### SUMMARY OF THE INVENTION

The aforementioned benefits may be met by incorporating into the aforementioned primary raw materials a combination of lecithin and hydrocolloid prior to dehydration processing and milling of primary components into nutritional powders suitable for encapsulation. Lecithin and the designated hydrocolloid materials are typical food items and are found in numerous types of consumer products.

The specific combination of lecithin and hydrocolloid enables the particle size reduction processing of dehydrated nutritional materials without the addition of milling agents to enhance processing rate and achieve proper powder particle size distribution.

The resultant nutritional powder is a homogenous powder of consistent color and having a particle size distribution suitable for encapsulation processing.

The specific combination of lecithin and hydrocolloid enables the encapsulation of nutritional powders without the addition of excipient agents.

The resultant capsule is homogenous and of a consistent color without evidence of incorporation of excipient materials.

Additionally, the free flowing nutritional powders can be used in other nutritional delivery formats such as tablets, rehydratable mixtures, energy bars, fortified foods and snacks as they offer convenient storage and handling and are able to be intimately mixed with other types of nutritional powders and ingredients.

### DETAILED DESCRIPTION OF THE INVENTION

Advantages of the present invention will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The compositional basis of the present invention offers the advantage that such dehydrated nutritional materials do not require milling agents for particle size reduction to a free flowing powder or excipient agents for encapsulation processing. This also eliminates color discrepancies which may occur between the nutritional material and milling or excipient agents which can adversely affect finished capsule appearance.

Furthermore, the compositional basis of the nutritional powder can be designed to deliver specific nutritional benefits or natural color for the final encapsulated product. The free flowing powders of the present invention are designed to be used as an ingredient in encapsulated products.

The invention also provides methods for producing free flowing nutritional powders of the present invention.

The primary component can be selected, derived, or extracted from the group of fruits including Genus; Malus (apple), Citrus (orange, lemon, lime), Vitis (grapes), Prunus (peach, cherry, plum), Vaccinium (cranberry, blueberry, bilberry), Ribes (black currant, red currant), Rubus (blackberry, raspberry), Sambucus (elderberry), Aronia (chokeberry), Elgeagnus (autumn olive), Ananus (pineapple), Punica (pomegranate), Carica (papaya), Malphighia (acerola cherry) Myrciaria (camu camu), Phoenix (dates), Euterpe (acai), Psidium (guava), Mangifera (mango), Passiflora (passionfruit), Averrhoa (starfruit) and combinations thereof.

The primary component can be selected or derived, or extracted from a group of vegetables belonging to the genus Curcurbita (squash, pumpkin), Brassica (cabbage, cauliflower, broccoli), Beta (beet, swiss chard), Daucus (carrot), Apium (celery), Spinacia (spinach), Capsicum (peppers), Solanum (tomato, potato), Ipomoea (sweet potato), Dioscorea (yams), Zea (corn), Pisum (green peas), Phaseolus (beans), Lens (lentils), Mushroom (various genus) and combinations thereof.

The primary component can ALSO be selected, derived or extracted from a group of grasses belonging to Genus; Medicago (alfalfa), Hordeum (barley), Triticum (wheat), Avena (oats) Oryza (rice) Zea (corn).

The primary component can be selected, derived, or extracted from a group of herbs belonging to Genus; Petruselinum (parsley), Ocimum (basil), Rosmarinus (rosemary), Origanum (oregano), Coriandrum (coriander), Anthenum (dill), Salvia (sage, chia), Artemisia (terragon), and combinations thereof.

The primary component can be selected, derived, or extracted from a group of Algae belonging to Genus; Chlorella, Spirulina, Bacillariophyceae, Chlorophyceae, Cryptophyceae, Eustignatophyceae, Prasinophyceae, Prymneiophyceae, and combinations thereof.

Lecithin is a term to designate any group of yellow-brownish fatty substances occurring in animal and plant tissues composed of phosphoric acid, choline, fatty acids, glycerol, glycolipids, triglycerides, and phospholipids (e.g., phosphatidylcholine, phosphatidylethanolamine, and phosphatidylinositol).

A typical structure of phosphatidyl choline is below:

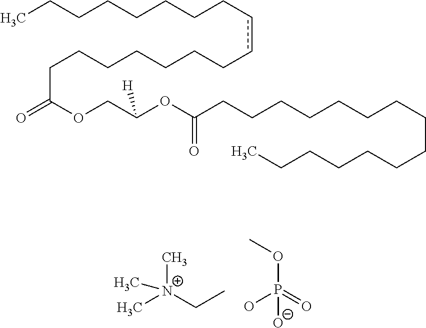

Lecithin has low solubility in water, but is an excellent emulsifier. In aqueous solution, its phospholipids can form either liposomes, bilayer sheets, micelles, or lamellar structures, depending on hydration and temperature. This results in a type of surfactant that usually is classified as amphipathic.

Examples of lecithin include: soy lecithin, sunflower seed lecithin, rice lecithin, and rapeseed lecithin.

Lecithin can be hydrolyzed. To modify the performance of lecithin to make it suitable for the product to which it is added, it may be hydrolysed enzymatically. In hydrolysed lecithins, a portion of the phospholipids have one fatty acid removed by phospholipase. Such phospholipids are called lysophospholipids. The most commonly used phospholipase is phospholipase A2, which removes the fatty acid at the C2 position of glycerol. Lecithins may also be modified by a process called fractionation. During this process, lecithin is mixed with an alcohol, usually ethanol. Some phospholipids, such as phosphatidylcholine, have good solubility in ethanol, whereas most other phospholipids do not dissolve well in ethanol. The ethanol is separated from the lecithin sludge, after which the ethanol is removed by evaporation to obtain a phosphatidylcholine-enriched lecithin fraction.

As an example, the major components of soybean-derived lecithin are:

33-35% Soybean oil

20-21% Inositol phosphatides

19-21% Phosphatidylcholine

8-20% Phosphatidylethanolamine

5-11% Other phosphatides

5% Free carbohydrates

2-5% Sterols

1% Moisture
Sunflower seed lecithin can have a 73% Phosphotide content, where fractionation with methanol can 41% phosphatidylcholine, 17% pohsphatidylethanolamine, 23% phosphatidylinositol, and 3% phosphatidic acid. The fatty acid of the phosphatide moiety can include 16.9% pamitic acid, 5.4% stearic acid, 8.6% oleic acid, 66.9% linoleic acid and 2.2% other fatty acids. See J. Hollo et al., J. Am. Oil Chemists Soc., JAOCS, vol. 70, No. 10 (October 1993).
There is also a hydrocolloid component.

Hydrocolloids are gums that are added to foodstuffs in order to control their functional properties, such as thickening or gelling.

Hydrocolloids, often called gums, are hydrophilic polymers, of vegetable, animal, microbial or synthetic origin, that generally contain many hydroxyl groups and may be polyelectrolytes. They are naturally present or added to control the functional properties of aqueous foodstuffs. Most important amongst these properties are viscosity (including thickening and gelling) and water binding but also significant are many others including emulsion stabilization, prevention of ice recrystallization and organoleptic properties. The degree with which the hydrocolloid solutions mix with saliva, determined by their degree of chain entanglement, determines flavor perception.

The functions hydrocolloids include adhesion, suspension, flocculation, foam stabilization and film formation. Foodstuffs are very complex materials and this together with the multifactorial functionality of the hydrocolloids has resulted in several different hydrocolloids being required. Some examples of hydrocolloids include agar, alginate, arabinoxylan, carrageenan, carboxymethyl cellulose, carboxyethyl cellulose cellulose, curdolan, celatin, gellan, β-glucan, guar gum, gum Arabic, locust bean gum, pectin, starch and xanthan gum.

The hydrocolloid component can be a single compound or mixture of compounds from various natural sources including: guar gum, gum arabic, xanthan gum, locust bean gum, pectin, carrageenan, alginate, and starch.

A preferred hydrocolloid is guar gum. Chemically, guar gum is a polysaccharide composed of the sugars galactose and mannose. The backbone is a linear chain of β 1,4-linked mannose residues to which galactose residues are 1,6-linked at every second mannose, forming short side-branches:

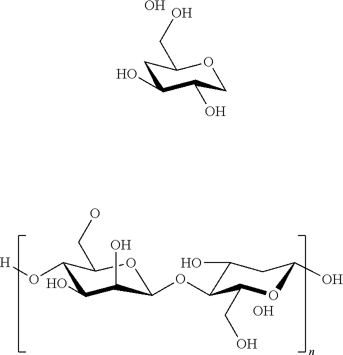

Guar gum is more soluble than locust bean gum and is a better stabilizer, as it has more galactose branch points. Unlike locust bean gum, it is not self-gelling. However, either borax or calcium can cross-link guar gum, causing it to gel. In water, it is nonionic and hydrocolloidal. It is not affected by ionic strength or pH, but will degrade at extremes pH and temperature (e.g., pH 3 at 50° C.). It remains stable in solution over pH range 5-7. Strong acids cause hydrolysis and loss of viscosity, and alkalies in strong concentration also tend to reduce viscosity. It is insoluble in most hydrocarbon solvents.

Guar gum shows high low-shear viscosity but is strongly shear-thinning. It is very thixotropic above 1% concentration, but below 0.3%, the thixotropy is slight. It has much greater low-shear viscosity than that of locust bean gum, and also generally greater than that of other hydrocolloids. Guar gum shows viscosity synergy with xanthan gum. Guar gum and micellar casein mixtures can be slightly thixotropic if a biphase system forms

Another hydrocolloid is hydroxypropy cellulose (KLUCEL), which is soluble in many polar organic solvents and in water below about 38° C., buts is insoluble in water above about 45° C.

The free flowing nutritional powder according to the present invention can be advantageously employed in fabricated nutritional product encapsulation manufacturing processes to enhance milling equipment and encapsulation equipment performance.

Accordingly, one aspect of the present invention relates to a free flowing nutritional powder suitable for encapsulation processing comprising an intimate mixture of a primary component or components originating or derived from fruits, vegetables, grasses, herbs, or algae that together represent at least about 85 wt. % of the dry matter contained in the powder along with a selection of one or more components from the group comprising lecithin which represents about 0.1-5.0 wt. % of the dry matter contained in the powder, and a selection of one or more components from the group comprising hydrocolloids which represent about 0.1-5.0 wt. % of the dry matter contained in the powder.

In the present invention, drying can include drum drying and the size reduction of the dehydrated homogenous mixture takes place via use of a universal mill (Fitzmill), pinmill, cone mill, jet mill, classifying mill, flaker, or combinations thereof. Less than about 5 wt. % of the particles contained in the free flowing powder have a particle size in excess of about 500 microns, less than about 15 wt. % of the particles contained in the free flowing powder have a particle size less than about 40 microns, and the free flowing powder has a moisture content of less than about 5 wt. % of not less than about 85 wt. % material selected or derived from fruits, vegetables, grasses, herbs, algae, or combinations thereof.

Another aspect of the present invention pertains to a free flowing nutritional powder, that includes at least one fruit, vegetable, grass, herbal or algal component; lecithin; and a hydrocolloid, where the free flowing powder has a mass weighted particle size within a range of about 10-600 microns, said free flowing powder has a water activity of less than about 0.50 and said powder contains at least about 85 wt. % of the fruit, vegetable, grass, herbal or algal component, about 0.1-5.0 wt. % of the lecithin, and about 0.1-5.0 wt. % of the hydrocolloid component.

The term ‘fruit’ as used herein comprises all parts of the plant eaten by humans, whole or in part, and includes one or more items originating from or derived from the group comprising fruit.

The term ‘vegetable’ as used herein comprises all parts of the plant eaten by humans, whole or in part, and includes one or more items originating from or derived from the group comprising vegetables.

The term ‘grasses’ as used herein comprises all parts of the plant eaten by humans, whole or in part, and includes one or more items originating from or derived from the group comprising grasses.

The term ‘herbs’ as used herein comprises all parts of the plant eaten by humans, whole or in part, and includes one or more items originating from or derived from the group comprising herbs.

The term ‘algae’ as used herein comprises all parts of the plant eaten by humans, whole or in part, and includes one or more items originating from or derived from the group comprising algae.

The term ‘intimate mixture’ as used herein refers to a mixture of particles in which particles of different composition are homogenously distributed throughout the mixture.

According to a particularly preferred embodiment the free flowing nutritional powder of the present invention has a uniform color distribution, meaning that to the naked eye the powder is perceived as being composed of particles having the same color.

As will be explained below, a nutritional powder having a uniform color distribution may suitably be produced by preparing an aqueous suspension of one or more of the primary components along with one or more components from the group comprising lecithin, and one or more components from the group comprising hydrocolloids. Accordingly, in a particularly preferred embodiment of the invention at least 3 primary components of dissimilar color are selected from the group comprising fruits, intimately mixed with a lecithin and hydrocolloid compound, dehydrated, and milled to a nutritional powder of uniform color and particle size distribution. As compared to, e.g., dry blended individual fruit powders, intimate mixtures of nutritional materials co-dried in this manner result in a powder of a uniform color and appearance.

Additionally, the co-dried powder does not require the addition of any excipient agents in order to achieve suitable encapsulation processing. The resultant capsule is of a uniform color as no off color excipient agent (typically white or off white) is required to be dry blended to achieve proper encapsulation.

The free flowing nutritional powder of the present invention has a moisture content of less than about 5.0 wt. %, preferably of less than about 3.0 wt. %, more preferably less than about 2.0 wt. %. The free flowing nutritional powder has a water activity of less than about 0.50_{wa} which is below the limit necessary to support growth of microorganisms. In particular, if the moisture content is below 3.0 wt. % and water activity is less than 0.40_{wa} the dehydrated nutritional powder will not support microbial growth and can be stored for more than 12 months under ambient conditions (20.0<65% RH).

It is preferred that the present powder does not contain any particles distinguishable by the naked eye as such large particles affect encapsulation processing as they cause voids in the capsule which do not meet capsule fill weight requirements. Accordingly, in the preferred embodiment, less than 5 wt. % of the powder has a particle size greater than about 600 microns, and more preferably, less than 5 wt. % of the powder has a particle size greater than about 500 microns. Accordingly, in the preferred embodiment, less than about 15 wt. % of the powder has a particle size less than 40 microns, and more preferably, less than about 10 wt. % of the powder has a particle size less than 40 microns.

The present free flowing nutritional powder is capable of being developed to deliver specific quantities of nutritional compounds as may be present or derived from the primary component group consisting of fruits, vegetables, grasses, herbs, and algae. Various combinations of such primary material mixtures can be designed to deliver a specific quantity of a nutritional compound or compounds present upon dehydration processing within a free flowing powder of a homogenous color that is stable when stored under ambient conditions.

The bulk density of the free flowing powder is typically within the range of about 0.25-0.7 g/cm, and most preferably between the range of about 0.3-0.6 g/cm.

In the present process the primary component can be introduced into the aqueous blend in the form of fresh fruits, vegetables, grasses, herbs, or algae, and combinations thereof; dried fruit vegetables, grasses, herbs, or algae, or combinations thereof; materials derived from fruits, vegetables, grasses, herbs, or algae via mechanical separation processing such as juice, seeds, skins, stems; or via extraction processing such as juice concentrate, deseeded purees, hot water and steam extracts, solvent extracts, condensed products, maltodextrins, fibers and phase separated products.

According to a particularly preferred embodiment of the present process the drying of the homogenous aqueous mixture includes drum drying. Drum drying offers the advantage that it can meet said residual moisture content and water activity level in dehydration processing of nutritional primary components.

The invention is further illustrated by means of the following examples.

### EXAMPLES

### Example 1

A free flowing nutritional powder of homogenous color free of milling agents or encapsulation excipients that can be used on a 100% basis for encapsulation processing.

A blended berry and green tea powder was prepared by first producing a smooth puree as follows: 300 parts by weight of blackberries, 300 parts by weight of red raspberries, 300 parts by weight of elderberries, and 300 parts by weight of red currants were introduced into a hammermill via conveyor and pulverized into a pumpable slurry. The pumpable slurry was transferred to a screen separator where oversize materials are removed and slurry is further reduced to a smooth consistency. The slurry is then transferred to an agitated tank where 20 parts by weight of green tea extract was added and allowed to intimately mix. Next 2.6 parts by weight of soya lecithin is added and allowed to intimately mix, and then 5.2 parts by weight of guar gum is added and allowed to intimately mix. The blended slurry is then transferred to a high speed shearing mill where it is further homogenized and rendered to a smooth slurry.

Subsequently, the vegetable puree mixture was dried on double drum dryers with the following settings 70 psi steam pressure (+/−3 psi), nip distance between drum approximately 0.02 inches (range 0.01 to 0.035 inches), 1.3 rpm drum setting, finished moisture target 2.5 wt. %. The processing parameters may be adjusted within the indicated ranges as needed to maintain finished product moisture, color and flavor within acceptable limits.

The dehydrated ‘flake’ material which comes off the drum dryer is transferred to a mill where it is reduced to a particle size range from 40 to 500 microns without the use of milling agents.

The resultant free flowing powder has a uniform purple color, moisture content of 1.9 wt. % and a water activity of 0.37_{wa} and is suitable for encapsulation processing without the use of excipient agents.

### Example 2

A free flowing nutritional fruit powder of homogenous color free of milling agents or encapsulation excipients that can be used on a 100% basis for encapsulation processing.

A fruit powder was prepared by first producing a smooth fruit puree as follows: 1200 parts by weight of blueberries were introduced into a hammermill via conveyor and pulverized into a pumpable slurry. The pumpable slurry was transferred to a screen separator where the blueberry seeds are removed and slurry is further reduced to a smooth consistency. The slurry is then transferred to an agitated tank where 1.8 parts by weight of sunflower lecithin is added and allowed to intimately mix, and then 2.7 parts by weight of guar gum is added and allowed to intimately mix. The blended slurry is then transferred to a high speed shearing mill where it is further homogenized and rendered to a smooth slurry.

Subsequently, the fruit puree mixture was dried on double drum dryers with the following settings: 75 psi steam pressure (+/−5 psi), nip distance between drum approximately 0.02 inches (range 0.01 to 0.035 inches), 1.6 rpm drum setting, finished moisture target 3 wt. %. The processing parameters may be adjusted within the indicated ranges as needed to maintain finished product moisture, color and flavor within acceptable limits.

The dehydrated ‘flake’ material which comes off the drum dryer is transferred to a mill where it is reduced to a particle size range from 40 to 500 microns without the use of milling agents.

The resultant free flowing powder has a uniform color, moisture content of 2.2 wt. %, and a water activity of 0.40_{wa} and is suitable for encapsulation processing without the use of excipient agents.

### Example 3

A free flowing nutritional vegetable powder of homogenous color free of milling agents or encapsulation excipients that can be used on a 100% basis for encapsulation processing.

A blended vegetable powder was prepared by first producing a smooth puree as follows: 300 parts by weight of cabbage, 300 parts by weight of broccoli, 300 parts by weight of carrot, and 300 parts by weight of kale were introduced into a hammermill via conveyor and pulverized into a pumpable slurry. The pumpable slurry was transferred to a screen separator where oversize materials are removed and slurry is further reduced to a smooth consistency. The slurry is then transferred to an agitated tank where 1.1 lbs of sunflower lecithin is added and allowed to intimately mix, and then 2.0 parts by weight of guar gum is added and allowed to intimately mix. The blended slurry is then transferred to a high speed shearing mill where it is further homogenized and rendered to a smooth slurry.

Subsequently, the vegetable puree mixture was dried on double drum dryers with the following settings 70 psi steam pressure (+/−3 psi), nip distance between drum approximately 0.02 inches (range 0.01 to 0.035 inches), 1.3 rpm drum setting, finished moisture target 2.5 wt. %. The processing parameters may be adjusted within the indicated ranges as needed to maintain finished product moisture, color and flavor within acceptable limits.

The dehydrated ‘flake’ material which comes off the drum dryer is transferred to a mill where it is reduced to a particle size range from 40 to 500 microns without the use of milling agents.

The resultant free flowing powder has a uniform green color, moisture content of 1.9 wt. %, and a water activity of 0.37_{wa} and is suitable for encapsulation processing without the use of excipient agents.

### Example 4

A free flowing concentrated cranberry nutritional powder of homogenous color free of milling agents or encapsulation excipients that can be used on a 100% basis for encapsulation processing.

A concentrated cranberry powder was prepared by first producing a smooth puree as follows: 2,586 parts by weight of water are introduced into an agitated tank, 125 parts by weight of dried cranberry skin powder is added and allowed to intimately mix for 10 minutes. Next, 250 parts by weight of 50 brix cranberry concentrate is added while agitating and allowed to intimately mix for 10 minutes. After the components are mixed 2.2 parts by weight of sunflower lecithin is added and allowed to intimately mix, and then 4.0 parts by weight of guar gum is added and allowed to intimately mix. The blended slurry is then transferred to a high speed shearing mill where it is further homogenized and rendered to a smooth slurry.

Subsequently, the cranberry concentrate and skin puree mixture was dried on double drum dryers with the following settings: 80 psi steam pressure (+/−3 psi), nip distance between drum approximately 0.02 inches (range 0.01 to 0.035 inches), 1.8 rpm drum setting, finished moisture target 2.5 wt. %. The processing parameters may be adjusted within the indicated ranges as needed to maintain finished product moisture, color and flavor within acceptable limits.

The dehydrated ‘flake’ material which comes off the drum dryer is transferred to a mill where it is reduced to a particle size range from 40 to 500 microns without the use of milling agents.

The resultant free flowing powder has a uniform color, moisture content of 1.8 wt. %, and a water activity of 0.35_{wa} and is suitable for encapsulation processing without the use of excipient agents.

### Example 5

A free flowing nutritional powder of homogenous color free of milling agents or encapsulation excipients that can be used on a 100% basis for encapsulation processing.

A blended berry and green tea powder was prepared by first producing a smooth puree as follows: 300 parts by weight of blackberries, 300 parts by weight of red raspberries, 300 parts by weight of elderberries, and 300 parts by weight of red currants were introduced into a hammermill via conveyor and pulverized into a pumpable slurry. The pumpable slurry was transferred to a screen separator where oversize materials are removed and slurry is further reduced to a smooth consistency. The slurry is then transferred to an agitated tank where 20 parts by weight of green tea extract was added and allowed to intimately mix. Next 2.6 parts by weight of soya lecithin is added and allowed to intimately mix, and then 5.2 parts by weight of guar gum is added and allowed to intimately mix. The blended slurry is then transferred to a high speed shearing mill where it is further homogenized and rendered to a smooth slurry.

Subsequently, the vegetable puree mixture was dried on double drum dryers with the following settings: 70 psi steam pressure (+/−3 psi), nip distance between drum approximately 0.02 inches (range 0.01 to 0.035 inches), 1.3 rpm drum setting, finished moisture target 2.5 wt. %. The processing parameters may be adjusted within the indicated ranges as needed to maintain finished product moisture, color and flavor within acceptable limits.

The dehydrated ‘flake’ material which comes off the drum dryer is transferred to a mill where it is reduced to a particle size range from 40 to 500 microns without the use of milling agents.

The resultant free flowing powder has a uniform purple color, moisture content of 1.9 wt. % and a water activity of 0.37_{wa} and is suitable for encapsulation processing without the use of excipient agents.

### Example 6

A free flowing apple powder of homogenous color free of milling agents or encapsulation excipients that can be used on a 100% basis for encapsulation processing.

A free flowing apple powder was prepared by first producing a smooth puree as follows: 3,000 parts by weight of apples were introduced into a hammermill via conveyor and pulverized into a pumpable slurry. The pumpable slurry was transferred to a screen separator where seeds and oversize materials are removed and slurry is further reduced to a smooth consistency. The slurry is then transferred to an agitated tank and heated to 85 deg C., then 50 parts by weight of corn maltodextrin is added and allowed to intimately mix. Next 4.5 parts by weight of soya lecithin is added and allowed to intimately mix, and then 3.0 parts by weight of guar gum is added and allowed to intimately mix. The blended slurry is then transferred to a high speed shearing mill where it is further homogenized and rendered to a smooth slurry.

Subsequently, the apple-maltodextrin puree mixture was dried on double drum dryers with the following settings: 75 psi steam pressure (+/−3 psi), nip distance between drum approximately 0.02 inches (range 0.01 to 0.035 inches), 1.8 rpm drum setting, finished moisture target 2.5 wt. %. The processing parameters may be adjusted within the indicated ranges as needed to maintain finished product moisture, color and flavor within acceptable limits.

The dehydrated ‘flake’ material which comes off the drum dryer is transferred to a mill where it is reduced to a particle size range from 40 to 500 microns without the use of milling agents.

The resultant free flowing powder has a uniform color, moisture content of 2.9 wt. %, and a water activity of 0.47_{wa} and is suitable for encapsulation processing without the use of excipient agents.

### Example 7

A free flowing prune fiber powder of homogenous color free of milling agents or encapsulation excipients that can be used on a 100% basis for encapsulation processing.

A free flowing prune powder was prepared by first producing a smooth puree as follows: 1,000 parts by weight of prunes were added to an agitated tank containing 2,086 parts by weight of water and heated to 85 deg C. for a period of 8 hours and mixed into a slurry. The pumpable slurry was transferred to a screen separator where the prune pits are removed and slurry is further reduced to a smooth consistency. The slurry is then transferred to a horizontal decanter centrifuge where the prune solids and juice are separated from the pumpable slurry. The prune solids are rejected from the horizontal decanter centrifuge and placed into a holding bin.

Then 400 parts by weight of prune solids are introduced into an agitated tank with 1,252 parts by weight of water and intimately mixed and heated to 65 deg C. After the tank reaches temperature 2.2 parts by weight of sunflower lecithin is added and allowed to intimately mix, and then 6.0 parts by weight of locust bean gum is added and allowed to intimately mix. The blended slurry is then transferred to a high speed shearing mill where it is further homogenized and rendered to a smooth slurry.

Subsequently, the prune fiber mixture was dried on double drum dryers with the following settings: 70 psi steam pressure (+/−3 psi), nip distance between drum approximately 0.02 inches (range 0.01 to 0.035 inches), 1.0 rpm drum setting, finished moisture target 2.5 wt. %. The processing parameters may be adjusted within the indicated ranges as needed to maintain finished product moisture, color and flavor within acceptable limits.

The dehydrated ‘flake’ material which comes off the drum dryer is transferred to a mill where it is reduced to a particle size range from 40 to 500 microns without the use of milling agents.

The resultant free flowing powder has a moisture content of 1.5 wt. % and a water activity of 0.33_{wa} and is suitable for encapsulation processing without the use of excipient agents.

### Example 8

A free flowing mixed grass powder of homogenous color free of milling agents or encapsulation excipients that can be used on a 100% basis for encapsulation processing.

A free flowing mixed grass powder was prepared by first producing a smooth puree as follows: 300 parts by weight of fresh wheatgrass and 300 parts by weight of fresh barley grass were added to an agitated tank containing 1,252 parts by weight of water and mixed into a slurry. The pumpable slurry was transferred to a high speed shear pump and the slurry is further reduced to a smooth homogenized consistency.

After the material has been reduced to a fine slurry 2.2 parts by weight of sunflower lecithin is added and allowed to intimately mix, and then 5.0 parts by weight of acacia gum is added and allowed to intimately mix. The blended slurry is then transferred to a high speed shearing mill where it is further homogenized and rendered to a smooth slurry.

Subsequently, the grass mixture was dried on double drum dryers with the following settings: 50 psi steam pressure (+/−10 psi), nip distance between drum approximately 0.02 inches (range 0.01 to 0.035 inches), 1.0 rpm drum setting, finished moisture target 2.5 wt. %. The processing parameters may be adjusted within the indicated ranges as needed to maintain finished product moisture, color and flavor within acceptable limits.

The dehydrated ‘flake’ material which comes off the drum dryer is transferred to a mill where it is reduced to a particle size range from 40 to 500 microns without the use of milling agents.

The resultant free flowing powder has a moisture content of 1.5 wt. % and a water activity of 0.33_{wa} and is suitable for encapsulation processing without the use of excipient agents.

### Example 9

A free flowing mixed algae powder of homogenous color free of milling agents or encapsulation excipients that can be used on a 100% basis for encapsulation processing.

A free flowing mixed algae powder was prepared by first producing a smooth puree as follows: 300 parts by weight of spirulina algae paste and 300 parts by weight of chorella algae paste were added to an agitated tank containing 2,504 parts by weight of water and mixed into a slurry. The pumpable slurry was transferred to a high speed shear pump and the slurry is further reduced to a smooth homogenized consistency.

After the material has been reduced to a fine slurry 0.6 parts by weight of sunflower lecithin is added and allowed to intimately mix, and then 4.0 parts by weight of acacia gum is added and allowed to intimately mix. The blended slurry is then transferred to a high speed shearing mill where it is further homogenized and rendered to a smooth slurry.

Subsequently, the grass mixture was dried on double drum dryers with the following settings: 50 psi steam pressure (+/−10 psi), nip distance between drum approximately 0.02 inches (range 0.01 to 0.035 inches), 1.0 rpm drum setting, finished moisture target 2.5 wt. %. The processing parameters may be adjusted within the indicated ranges as needed to maintain finished product moisture, color and flavor within acceptable limits.

The dehydrated ‘flake’ material which comes off the drum dryer is transferred to a mill where it is reduced to a particle size range from 40 to 500 microns without the use of milling agents.

The resultant free flowing powder has a moisture content of 1.9 wt. % and a water activity of 0.36_{wa} and is suitable for encapsulation processing without the use of excipient agents.

It is to be understood that the foregoing descriptions and specific embodiments shown herein are merely illustrative of the best mode of the invention and the principles thereof, and that modifications and additions may be easily made by those skilled in the art without departing for the spirit and scope of the invention, which is therefore understood to be limited only by the scope of the appended claims.

What is claimed is:

1. A process of manufacturing a free flowing nutritional powder, comprising:
combining a selected primary component or primary component mixtures along with a lecithin component and a hydrocolloid component to prepare an aqueous blend having a solids content of 4-20% by weight;
intimately mixing the resultant blend to produce a homogenous liquid mixture;
drying (dehydrating) the homogenous mixture; and
grinding or milling such dehydrated mixture to obtain the free flowing nutritional powder, wherein,
said free flowing powder has a mass weighted particle size within a range of 10-600 microns; said free flowing powder has a water activity of less than 0.50_{wa}, said intimate mixture contains at least 85 wt. % of the primary component, 0.1-5.0 wt. % of the lecithin component, and 0.1-5.0 wt. % of the hydrocolloid component.

2. The process according to claim 1, wherein the drying of the homogeneous mixture includes drum drying.

3. The process according to claim 1, wherein the size reduction of the dehydrated homogenous mixture takes place via use of a universal mill (Fitzmill), pinmill, cone mill, jet mill, classifying mill, flaker, or combinations thereof.

4. The process according to claim 1, wherein less than 5 wt. % of the particles contained in the free flowing powder have a particle size in excess of 500 microns.

5. The process according to claim 1, wherein less than 15 wt. % of the particles contained in the free flowing powder have a particle size less than 40 microns.

6. The process according to claim 1, wherein the free flowing powder has a moisture content of less than 5 wt. %.

7. The process according to claim 1, wherein said primary component consists of not less than 85 wt. % material selected or derived from fruits, vegetables, grasses, herbs, algae, or combinations thereof.

8. The process according to claim 1, wherein the lecithin component is soya lecithin or sunflower seed lecithin.

9. The process according the claim 1, wherein the hydrocolloid component is guar gum.

10. A free flowing nutritional powder, comprising:
at least one fruit, vegetable, grass, herbal or algal component;
lecithin; and
a hydrocolloid, wherein
said free flowing powder has a mass weighted particle size within a range of 10-600 microns, said free flowing powder has a water activity of less than 0.50_{wa}, and said powder contains at least 85 wt. % of the fruit, vegetable, grass, herbal or algal component, 0.1-5.0 wt. % of the lecithin, and 0.1-5.0 wt. % of the hydrocolloid component.

11. The free flowing nutritional powder according to claim 10, wherein less than 5 wt. % of the particles contained in the free flowing powder have a particle size in excess of 500 microns.

12. The free flowing nutritional powder according to claim 10, wherein less than 15 wt. % of the particles contained in the free flowing powder have a particle size less than 40 microns.

13. The free flowing nutritional powder according to claim 10, wherein the free flowing powder has a moisture content of less than 5 wt. %.

14. The process according to claim 10, wherein the lecithin component is soya lecithin or sunflower seed lecithin.

15. The free flowing nutritional powder according the claim 10, wherein the hydrocolloid component is guar gum.

16. The free flowing nutritional powder according the claim 10, which is encapsulated.

17. A process of manufacturing a free flowing nutritional powder, comprising:
combining of not less than 85 wt. % material selected or derived from fruits, vegetables, grasses, herbs, algae, or combinations thereof along with soya or sunflower lecithin and a hydrocolloid to prepare an aqueous blend having a solids content of 4-20% by weight;
intimately mixing the resultant blend to produce a homogenous liquid mixture;
drying (dehydrating) the homogenous mixture; and
grinding or milling such dehydrated mixture to obtain the free flowing nutritional powder, wherein,
said free flowing powder has a mass weighted particle size within a range of 10-600 microns; said free flowing powder has a water activity of less than 0.50_{wa}, said intimate mixture contains at least 85 wt. % of the primary component, 0.1-5.0 wt. % of the lecithin component, and 0.1-5.0 wt. % of the hydrocolloid component.

18. The process according to claim 17, wherein the hydrocolloid is guar gum.
